(19) United States
(12) Patent Application Publication
(10) Pub. No.: US 2010/0031016 A1
(43) Pub. Date: Feb. 4, 2010

(54) PROGRAM METHOD, AND DEVICE FOR ENCRYPTION COMMUNICATION

(75) Inventors: Yoshio NAWATE, Kawasaki (JP); Jun Yajima, Kawasaki (JP); Hiroyuki Komori, Kawasaki (JP); Arata Noguchi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 12/029,740

(22) Filed: Feb. 12, 2008

(30) Foreign Application Priority Data
Feb. 16, 2007 (JP) 2007-36895

(51) Int. Cl. H04L 9/32; H04L 29/06

(52) U.S. Cl. 713/151; 713/168

(57) ABSTRACT

An encryption communication method for performing communication that includes a data transfer phase for transmission of content data and a handshake phase for user authentication or agreement on the transmission method for content data, the method comprising: storing one set of a plurality of content data for multiple users in a common transmission communication region provided for the multiple users; transferring the stored one set of the plurality of content data during the data transfer phase when transferring content data of the multiple users to a communication target device; and receiving the stored one set of the plurality of content data using a plurality of transmission-reception communication regions provided for each of the multi users is provided.

### CROSS-REFERENCE TO RELATED APPLICATIONS

This application claims the benefit of priority from Japanese Patent Application No. 2007-036895 filed on Feb. 16, 2007, the entire contents of which are incorporated herein by reference.

### BACKGROUND OF THE INVENTION

1. Field of the Invention

This application relates to encryption communication utilizing security technology, and in particular to encryption authentication.

2. Description of Related Art

TLS (Transport Layer Security) and SSL (Secure Socket Layer), which are standards of secure data communication, can be implemented, for example, even when performing multitask functions (i.e., parallel execution of multiple processes simultaneously by one computer). TLS/SSL communication has a handshake phase and a data transfer phase. During the handshake phase, Authentication and negotiation of the encryption method and the key thereof are performed between the opposing server and client. During the data transfer phase, exchange of data encrypted using an agreed encryption method and key takes place between the authenticated opposing server and client.

When users perform TLS/SSL communication for multitask operations with an opposing server or client, a dedicated respective reception buffer region is provided for each user that is used for data reception, and a respective dedicated transmission buffer region is provided for each user, which is used for data transmission.

The volume of data requested by the user and the volume of data transmitted by the opposing server/client are not related. Thus, situations such as overwriting of other user data and the like occur when a reception buffer is shared by multiple users. For this reason, a respective data reception buffer region must be allocated for each user.

Also, as mentioned in Japanese Laid-open Patent Publication No. 2002-351835, when TTL/SSL communication is implemented by using an embedded device having a limited memory size, there is a need to make the memory size as small as possible.

### SUMMARY

According to one aspect of an embodiment of the present invention, an encryption communication method for performing communication that includes a data transfer phase for transmission of content data and a handshake phase for user authentication or agreement on the transmission method for content data, the method comprising: storing one set of a plurality of content data for multiple users in a common transmission communication region provided for the multiple users; transferring the stored one set of the plurality of content data during the data transfer phase when transferring content data of the multiple users to a communication target device; and receiving the stored one set of the plurality of content data using a plurality of transmission-reception communication regions provided for each of the multi users is provided.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 is a diagram showing an encrypted record in accordance with an embodiment of the present invention.

FIG. 2 is a diagram showing various features in accordance with a first embodiment of the present invention.

FIG. 3 is a block diagram showing the overall system of the embodiment of FIG. 1.

FIG. 4 is a diagram detailing the handshake phase in accordance with an embodiment of the present invention.

FIG. 5 is a diagram detailing the data transfer phase in accordance with an embodiment of the present invention.

FIG. 6 is a diagram showing an example hardware configuration of the client device in accordance with an embodiment of the present invention.

FIG. 7 is a block diagram showing various functions of the client device in accordance with a second embodiment of the present invention.

FIG. 8 is a block diagram showing functions of the CPU in accordance with an embodiment of the present invention.

FIG. 9 is a sequence diagram showing operation during the handshake phase in accordance with an embodiment of the present invention.

FIG. 10 is a sequence diagram showing operation during the data transfer phase in accordance with an embodiment of the present invention.

FIG. 11 is a block diagram showing functions of the client device in accordance with a third embodiment of the present invention.

FIG. 12 is a sequence diagram showing operation during the handshake phase of the third embodiment of the present invention.

FIG. 13 is a sequence diagram showing operation during the data transfer phase of the third embodiment of the present invention.

### DESCRIPTION OF PREFERRED EMBODIMENTS

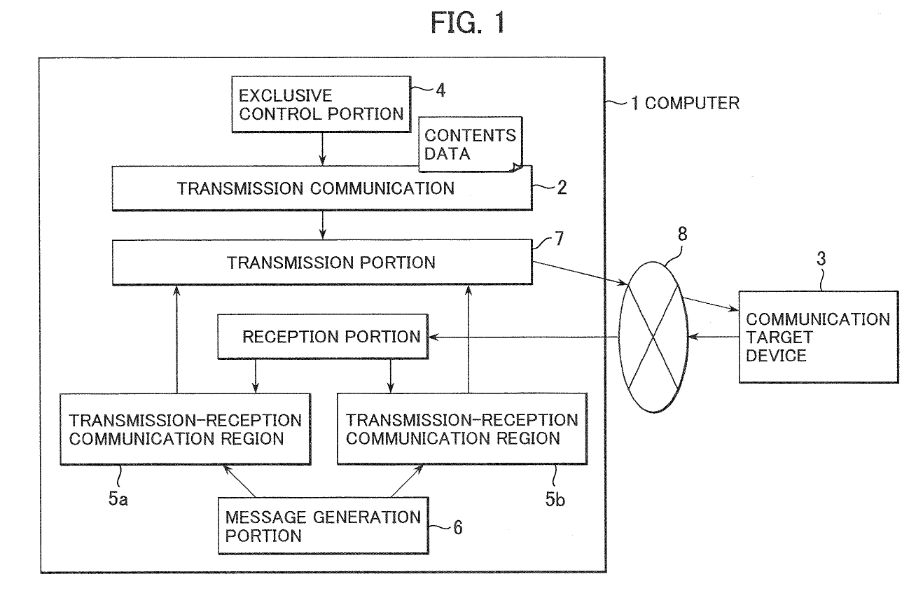

FIG. 1 shows a representative diagram of various features in accordance with a first embodiment of the present invention.

The embodiment shown in FIG. 1 includes a computer or other processing device 1 for executing an encryption communication program, a transmission communication region 2, an exclusive control portion 4, transmission-reception communication regions 5a and 5b, a message generation portion 6, a transmission portion 7.

The transmission communication region 2 may be provided within the computer 1, for example, and be capable of being shared by multiple users. During the data transmission phase to the communication target device 3 by multiple users, one portion of the content data from among the multiple content data transmitted to the communication target device 3 is stored in the transmission communication region 2.

During the data transfer phase, the exclusive control portion 4 allows transmission of only content data stored in the transmission region 2, from among the multiple content data, to the communication target device 3. The Transmission-reception communication regions 5a and 5b are allocated to each user. The volume of each of the transmitting and receiving transmission-reception communication regions 5a and 5b is set so as to be larger than the transmission communication region 2.

During the handshake phase, the message generation portion 6 generates a message for each user to be transmitted to the communication target device 3, and the generated messages are stored in the transmission-reception communication regions 5a and 5b.

The transmission portion 7 transmits the respective messages stored in the transmission-reception communication regions 5a and 5b.

According to the encryption communication program of this embodiment, during the handshake phase, the message generation portion 6 generates a message for each user, to be sent the communication target device 3. The generated messages are stored in the transmission-reception communication regions 5a and 5b. Then, the transmission portion 7 transmits the messages stored in the transmission-reception communication regions 5a and 5b.

During the data transmission phase to the communication target device 3 for multiple users, one portion of content data is stored in the transmission communication region 2. The exclusive control portion 4 allows of transmission only the content data stored in the transmission communication region 2 to the communication target device 3.

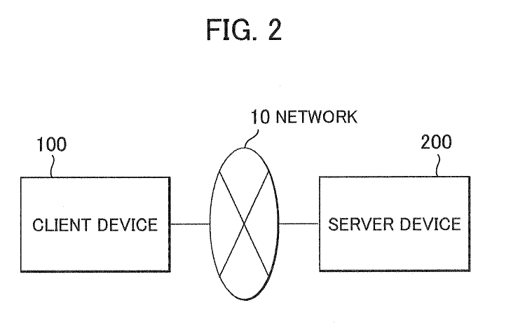

FIG. 2 is a block diagram showing a system in accordance with the embodiment of FIG. 1.

In the system of FIG. 2, a client device (computer) 100 and a server device (communication target device) 200 are coupled via a network 10.

The client device 100 and the server device 200 transmit and receive data via TLS/SSL communication, in the following manner.

(1) The client device 100 notifies the server device 200 of the type of encryption that can be used when encrypting the communication data. Thereafter, the client device 100 and the server device 200 select a common-key code.

(2) The server device 200 transmits a public key encryption certificate with a signature.

(3) The client device 100 confirms the signature by using the imported root certificate, and authenticates the server device 200.

(4) The client device 100 generates a common key for encryption, encrypts the common key using the public key of the server device 200, and transmits the encrypted common key.

(5) The server device 200 decrypts using a secret key for the server device 200, and then extracts the common key.

(6) The client device 100 and the server device 200 start encrypted communication using the respective common keys.

The authentication and negotiation encryption method for the key with respect to the aforementioned client device 100 and server device 200, is performed via the handshake phase. Thereafter, the client device 100 and the server device 200 perform data transfer phase using the key and encryption method determined during the handshake phase.

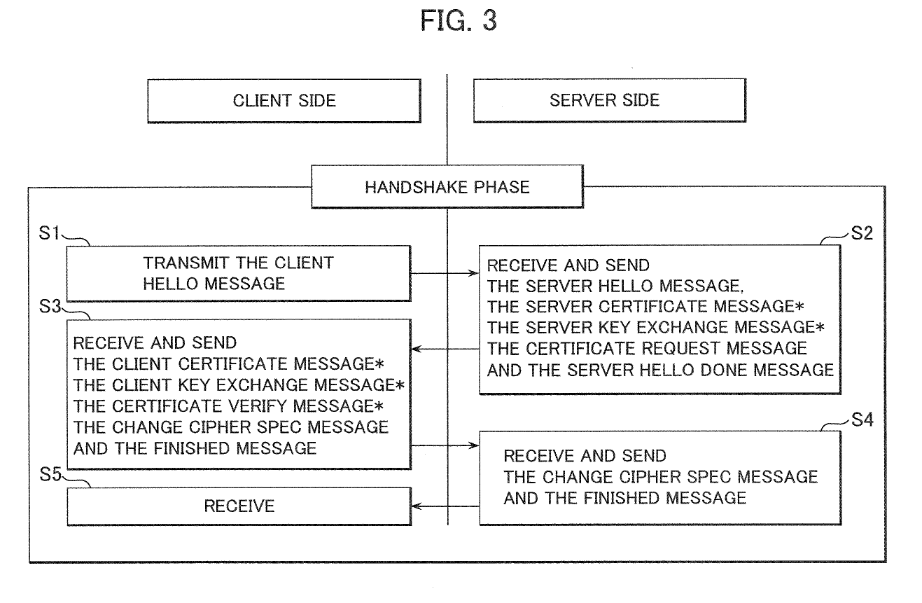

FIG. 3 is a diagram of an exemplary handshake phase in accordance with an embodiment of the present invention.

During the handshake phase, the client device 100 transmits a Client Hello message to the server device 200 (step S1).

The server device 200 receives the Client Hello message. Thereafter, the server device 200 transmits to the client device 100 a Server Hello message, a Server Certificate message, a Server Key Exchange message, a Certificate Request message, and a Server Hello Done message (step S2).

The client device 100 receives these messages and transmits to the server device 200 a Client Certificate message, a Client Key Exchange message, a Certificate Verify message, a Change Encryption Spec message, and a Finished message (step S3).

The server device 200 receives these messages and transmits to the client device 100 a Change Encryption Spec message and a Finished message (step S4).

The handshake phase is completed when the client device 100 receives these messages (step S5). The messages marked with the asterisk symbol among the messages shown in FIG. 3 are optional messages, and the transmission of such messages is, accordingly, optional.

Details regarding the messages within FIG. 3 are as follows.

The Client Hello message is sent to the server device 200 in the following cases:

(1) when connecting the client device 100 initially to the server device 200,

(2) when receiving a Hello Request message from the server device 200, and

(3) when changing the encryption parameters in an existing connection.

The Client Hello message comprises a list and associated data for candidates for the utilized encryption method and the data compression method. In order to prevent a replay attack (i.e., attack method of fooling a communicating entity by reuse of the contents of communication exchanged previously between normal users), the Client Hello message includes one-time-only random data.

The Server Hello message is a reply message from the server device 200 in response to Client Hello message. The Server Hello message includes one-time-only random data that differs from that of the Hello Client message generated independently by the server device 200. An algorithm selected from a list of encryption processing/compression algorithms supported by the client device 100 is used in preparing this message.

The Server Certificate message is sent to the client device 100 from the server device 200. The server device 200 utilizes the Server Certificate message to transmit the certificate of the server device 200 to the client device 100. The Server Certificate message is sent in the format of a list, including the certificate chain up to a root authority, which includes a certificate of the certification authority issuing the certificate, and a certificate of a higher certification authority, if such a higher certification authority exists.

The Server Key Exchange message is sent from the server device 200 to the client device 100 when the server device 200 does not possess a certificate, and when the certificate is only used for a signature, including in the case that the server device 200 possesses the certificate.

The Client Exchange message is sent from the server device 200 to the client device 100 to request presentation of the certificate of the client from the server device 200 when performing client authentication. A list of authorities trusted by the server device 200 is appended to this message.

The Server Hello Done message provides notification to the client device 100 that a series of message supporting key exchange has been sent from the server device 200 to the client device 100.

The Client Certificate message is a message from the client device 100 transmitting the certificate of the client device 100 to the server device 200 when performing client authentication.

The Client Key Exchange message is a message from the client device 100 to the server device 200 transmitting pre-master secret data that is used for generation of a master secret. The master secret is used for generating security parameters, such as the key used for encryption during a session (session key), and the like. For example, in the case of use of a RSA algorithm, the pre-master secret data is encrypted using a public key received from the server.

The Certificate Verify message is a message for the server device 200 to transmit data required for authentication of the client. Specifically, the hash value of the messages heretofore described between the client device 100 and the server device 200 in the handshake phase is included in the Certificate Verify message, and is encrypted using the private key of the client. The server device 200 decrypts the Certificate Verify message using the public key of the client, and authenticates the message by comparing the decrypted result with a hash value acquired in the same manner.

The Change Encryption Spec message is a message for notifying another entity of the start of use of a security parameter or encryption specification determined in the handshake phase.

The Finished message is the first message that is protected by a negotiated encryption specification, key, and secret. As a result, the Finished message notifies each receiving entity that negotiation between both the server device 200 and the client device 100 has been performed successfully.

It is noted that processing in the handshake phase is typically slow, due to use of the public key encryption method, authentication processing, and response wait processing. (Hereafter the messages utilized in the handshake phase are referred to as “handshake messages”.)

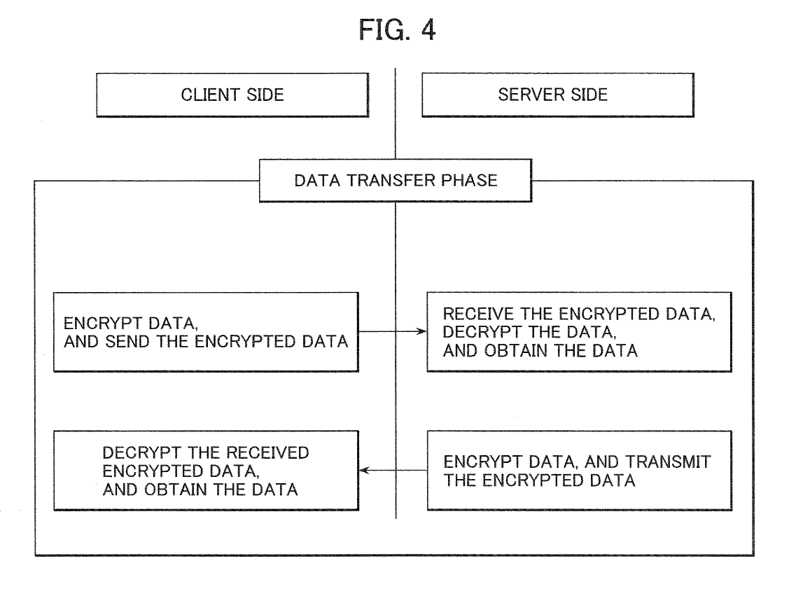

FIG. 4 is a diagram of the data transfer phase, in accordance with an embodiment of the present invention.

In the data transfer phase, when data is transmitted from the client device 100 to the server device 200, the client device 100 encrypts the data to be transmitted and generates encrypted data (a record). Thereafter, the client device 100 transmits the encrypted data. The server device 200 receives the encrypted data and decrypts the encrypted data.

When the server device 200 transmits data to the client device 100, the server device 200 encrypts and transmits the data to be sent. The client device 100 receives the encrypted data and decrypts the encrypted data.

Since processing in the data transfer phase uses the common key encryption method, and the data is encrypted and transmitted unilaterally, the processing in this phase is typically faster than processing in the handshake phase.

The data storage region used for these data communication will now be explained in greater detail.

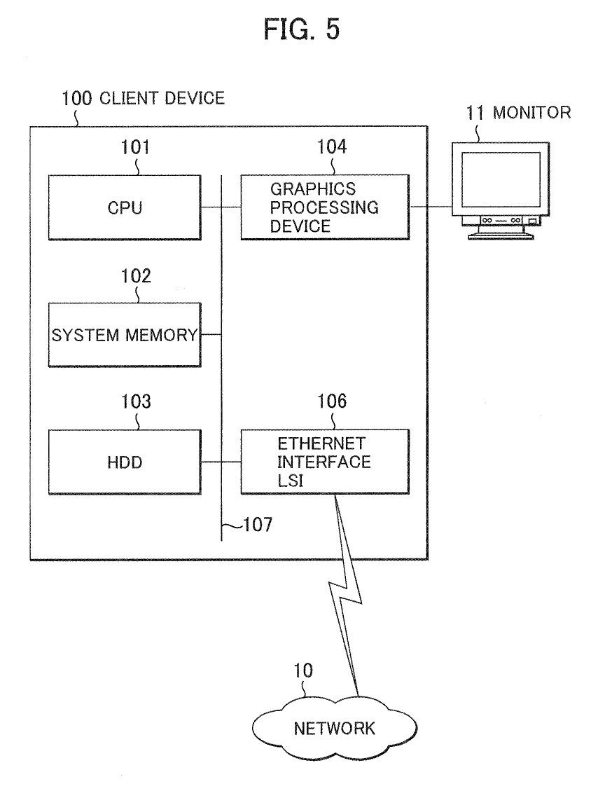

FIG. 5 is a diagram showing an exemplary hardware configuration for the client device in accordance with an embodiment of the present invention.

At the client device 100, a CPU (Central Processing Unit) 101 controls the entire device 100. The CPU 101 is coupled to a system memory 102 through a bus 107, a hard disk drive (HDD) 103, a graphics processing device 104, and an LSI (Ether Connect LSI) 106, which is used for connection to an Ethernet®.

At least part of the application programs and the multi-tasking OS (Operating System) programs executed by the CPU 101 are stored temporarily in the system memory 102. Various types of data and the like required for processing by the CPU 101 are also stored in the system memory 102. The OS and application programs are stored on the HDD 103. Program files are also stored on the HDD 103.

The graphics processing device 104 is coupled to a monitor 11. The graphics processing device 104 follows commands from the CPU 101 and displays an image on the screen of the monitor 11.

The Ethernet interface LSI 106 is coupled to a network 10. The Ethernet interface LSI 106 transmits and receives data to and from the server device 200 through the network 10.

The processing functions of the first embodiment can be implemented using the aforementioned hardware configuration. Although the hardware configuration of the client device 100 is shown in FIG. 5, the server device 200 can also be implemented using other similar hardware configurations. In a system having this type of hardware configuration, the following functions are provided within the client device 100 for transmitting encrypted data.

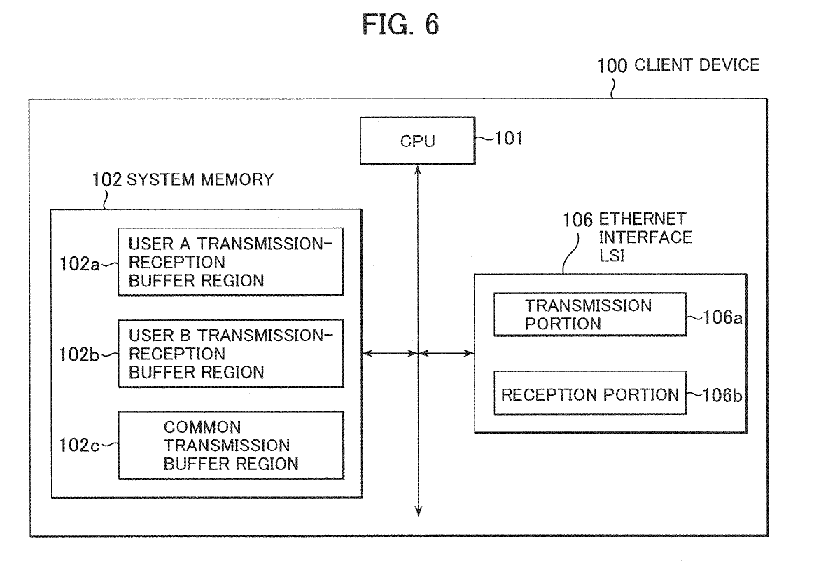

FIG. 6 is a block diagram showing functions of the client device of a second embodiment of the present invention.

Example operations by a first user A (multi-user A) and a second user B (multi-user B) performing TLS/SSL communication with a server device 200 through a client device 100 will now be described.

The system memory 102 of the client device 100 has a transmission-reception communication buffer region 102a used for user A, a transmission-reception communication buffer region 102b used for user B, and a common transmission buffer region 102c.

The transmission-reception communication buffer region 102a used for user A has a buffer region allocated to user A for data reception and handshake transmission.

The transmission-reception communication buffer region 102b used for user B has a buffer region allocated to user B for data reception and handshake transmission.

The common transmission buffer region 102c has a buffer region used for transmissions shared by user A and user B. Each of these buffer regions is allocated within the system memory 102 according to system operation described further below.

TLS/SSL communication converts the content data sent from the opposing server/client in the data transfer phase into units of data (i.e., encoded records). The media access control (MAC) value of the record is verified.

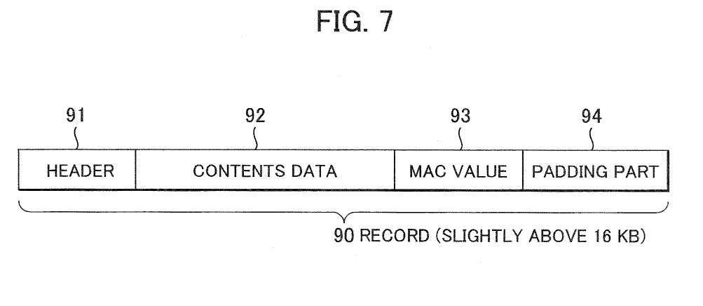

FIG. 7 is a diagram showing an example encrypted record in accordance with an embodiment of the present invention.

The record 90 has a header 91, a content data portion 92, a MAC value portion 93, and a padding part 94.

The MAC value verification provides checking of whether or not the message is the unaltered original message, by using a value obtained by the hash function. However, TLS/SSL communication is unable to execute MAC value verification for a record unless the entire record is received. Thus, a data reception buffer region must be prepared which has a size slightly larger than the 16 KB maximum size of the record unit.

In order to perform this operation, the buffer regions for receiving and transmitting in the handshake phase are set to slightly larger than 16 KB. Additionally, the size of the common transmission buffer region 102c is set, for example, to about 1 KB-2 KB.

In this example, the Ethernet interface LSI 106 has at least one transmission portion (block dedicated to transmission use) 106a and one reception portion (block dedicated to reception use) 106b.

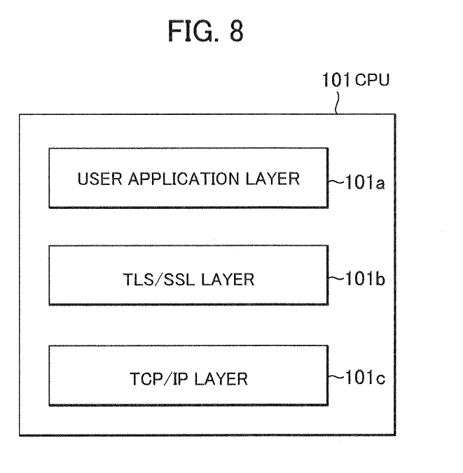

FIG. 8 is a block diagram showing functions of the CPU in accordance with an embodiment of the present invention.

The CPU 101 includes a user application layer 101a, a TLS/SSL layer 101b, and a TCP/IP layer 101c.

The user application layer 101a is located at the top of TCP/IP, as shown in FIG. 8, and the application layer 101a implements negotiation of a different protocol for each type of service.

The TLS/SSL layer 101b is a layer immediately below the user application layer 101a, as shown in FIG. 8, and the TLS/SSL layer 101b executes data encryption. The TLS/SSL layer 101b assures validity of the server device 200 and the client device 100, based on the digital certificate issued by the certification authority.

The TCP/IP layer 101c controls information that should be passed to the server device 200 and information about the state of a packet.

System operation in the handshake phase and the data transfer phase will now be described in further detail.

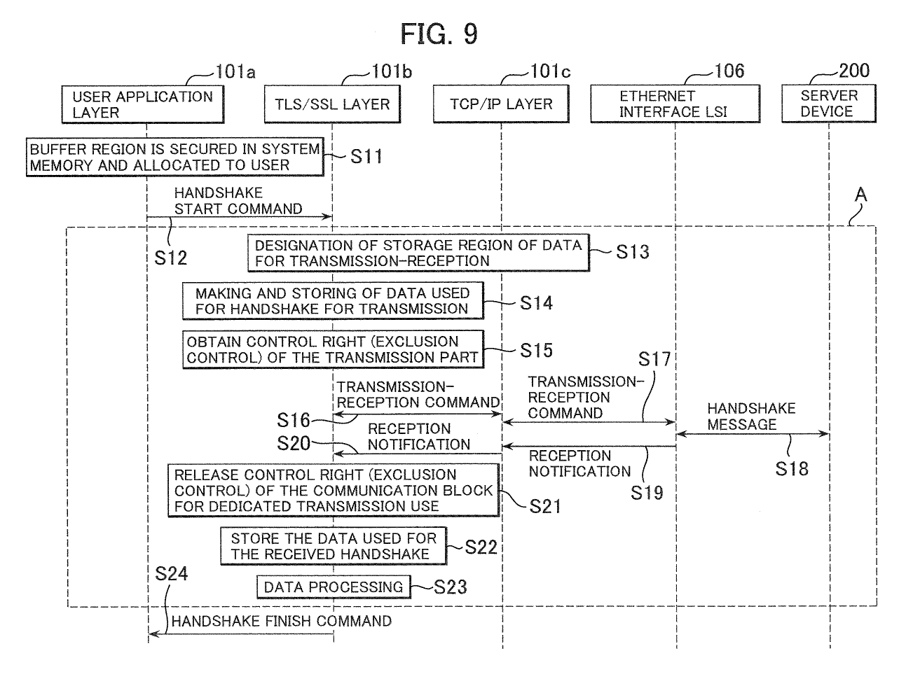

FIG. 9 is a sequence diagram showing operations of the handshake phase in accordance with an embodiment of the present invention.

Initially, the user application layer 101a allocates, in the system memory 102 (FIG. 5), a common transmission buffer region 102c (FIG. 6, e.g., 2 KB), along with reception joint handshake transmission buffer regions for each of the multi-users (e.g., 16 KB each), and these regions are allocated for each of the multi-users (step S11). According to the second embodiment, the volume for allocation for user A transmission-reception buffer region 102a (FIG. 6) plus for user B transmission-reception buffer region 102b (FIG. 6) becomes, for example, 16 times 2=32 KB.

Thereafter, the user application layer 101a transmits a handshake start command to the TLS/SSL layer 101b (step S12).

The TLS/SSL layer 101b that received the handshake start command sets the reception joint handshake transmission buffer region allocated for each user (step S13). Specifically, the storage region for transmitting and receiving data by user A is set as the user A transmission-reception buffer region 102a (FIG. 6), and the storage region for data transmitting and receiving by user B is set as the user B transmission-reception buffer region 102b (FIG. 6). In FIG. 9, a block crossing (e.g., S13) between the TLS/SSL layer 101b and the TCP/IP layer 101c indicates that a determined item in the TLS/SSL layer 101b is also reflected in the TCP/IP layer 101c (this indication is similar for other figures as well).

Thereafter, the TLS/SSL layer 101b creates handshake data that is transmitted to the server device 200 and the like, and such data are stored in the user A transmission-reception buffer region 102a (FIG. 6) and the user B transmission-reception buffer region 102b (FIG. 6) (step S14). The TLS/SSL layer 101b obtains the control rights (exclusive control) of the transmission portion 106a (FIG. 6) (step S15).

Next, the TLS/SSL layer 101b transmits, to the TCP/IP layer 101c, a transmission-reception command for handshake data (hereinafter, for simplicity, this example refers only to data for handshake use stored in user A transmission-reception buffer region 102a (FIG. 6), although this embodiment is not limited to this example) stored in either the user A transmission-reception buffer region 102a (FIG. 6) or the user B transmission-reception buffer region 102b (FIG. 6) (step S16).

When the TCP/IP layer 101c receives the transmission-reception command from the TLS/SSL layer 101b, the TCP/IP layer 101c transmits a transmission-reception command to the Ethernet interface LSI 106 (step S17).

When the transmission-reception command is received, the Ethernet interface LSI 106 performs an exchange of handshake messages with the server device 200 (step S18).

When the exchange of handshake messages is complete, the Ethernet interface LSI 106 transmits notification of reception to the TCP/IP layer 101c (step S19).

After the TCP/IP layer 101c has received the notification of reception, the TCP/IP layer 101c transmits the received notification of reception to the TLS/SSL layer 101b (step S20).

When the TLS/SSL layer 101b receives the notification of reception from the TCP/IP layer 101c, the TLS/SSL layer 101b releases the control rights (exclusion control) for the communication block dedicated for transmission use (step S21). Thereafter, the TLS/SSL layer 101b stores the received handshake data in the user A transmission-reception buffer region 102a (FIG. 6) (step S22).

Following this action, the TLS/SSL layer 101b performs negotiation (data processing) with respect to the authentication method, encryption method, and key for encryption method (step S23).

In the handshake phase, the operations of steps S13 through S23 are repeated for each user (see operations enclosed by the dashed line “A” in FIG. 9). At the time of completion of the handshake phase, the TLS/SSL layer 101b transmits a handshake end command to the user application layer 101a (step S24). After completion of the handshake phase, the CPU 101(FIG. 5, FIG. 6) starts the data transfer phase.

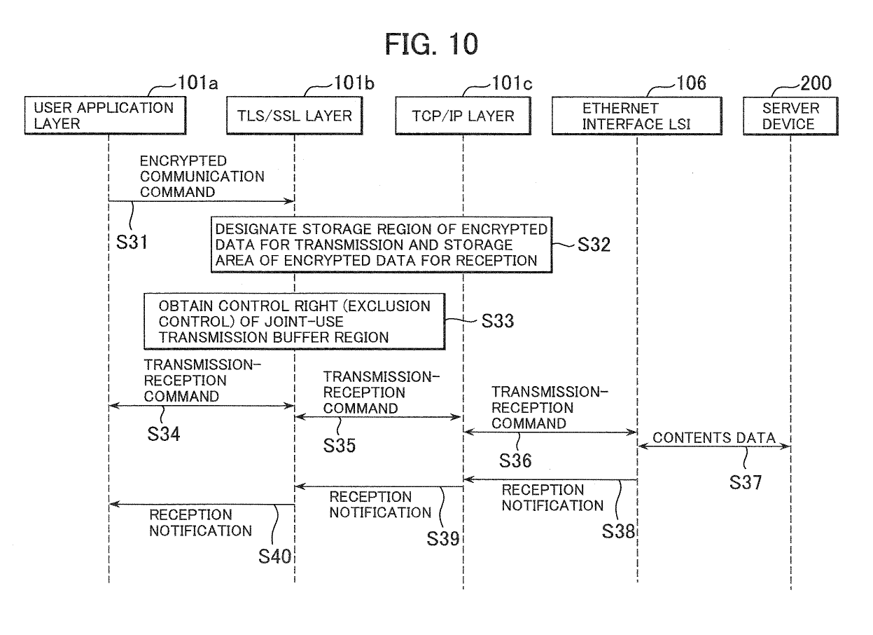

FIG. 10 is a sequence diagram showing operation of the data transfer phase in accordance with an embodiment of the present invention.

First, when contents data for transmission are received, the user application layer 101a transmits an encryption communication command to the TLS/SSL layer 101b (step S31).

The TLS/SSL layer 101b sets the storage region of the encrypted record to be transmitted to the common transmission buffer region 102c (FIG. 6), sets a storage region for receiving the encrypted record for user A to the user A transmission-reception buffer region 102a (FIG. 6), and sets a storage region for receiving the encrypted record for user B to the user A transmission-reception buffer region 102b (FIG. 6) (step S32).

Thereafter, the TLS/SSL layer 101b obtains control rights (exclusive control) of the common transmission buffer region 102c (FIG. 6) (step S33). Alternatively, for example, it is possible for the TLS/SSL layer 101b to transmit the exclusive control command to the user application layer 101a, and the user application layer 101a to perform exclusive control.

Then, using exclusive control of the interrupt processing control function for restricting use from a signal (semaphore) exchanged between processes, content data from the common transmission buffer region 102c (FIG. 6) is transmitted in the transfer phase (steps S34 through S40). The setting of each buffer region at the time of transmission-reception is performed by setting the buffer as the argument of the function handling the socket dedicated to transmission of The TLS/SSL layer 101b and the socket dedicated for reception of The TLS/SSL layer 101b.

As the second embodiment includes use of TLS, which has the characteristic that transmission speed is slow in the handshake phase, and that the reception buffer region is empty in the handshake phase, the handshake message is exchanged using the user A transmission-reception buffer region 102a (FIG. 6) and the user B transmission-reception buffer region 102b (FIG. 6). As a result, no monopolization of the transmission-use buffer regions occurs during message transmission for a certain user. Therefore, communication can occur without reduction in performance.

Moreover, in consideration of the fact that the entity transmitting data is the user, exclusion control may be used to ensure that two users do not use the transmission buffer region simultaneously, and that all users are able to commonly use the transmission buffer region. Further, utilizing the characteristic that the user transfers content data unilaterally in the data transfer phase, and that processing speed in the data transfer phase is high, the common transmission buffer region 102c (FIG. 6) may be used in the data transfer phase and exclusive control is performed, such that simultaneous use by two users does not occur. Even if exclusive control is used and the transmission-use buffer region is used commonly by multiple users in the data transmission phase for each user, the overall loss of performance may be maintained within a permissible range. In the data transfer phase, lowering of performance is prevented, and the size of memory required can be reduced.

As a result, configuration and control are uncomplicated, with this embodiment and implementation is made possible using a simple configuration. If the number of multi-users is 10, for example, the communication buffer region size (i.e., size of the buffer region required for transmission-reception) is 10 (number of multi-users) times {16 KB (reception buffer region)+2 KB (transmission buffer region)}=180 KB. The communication buffer region size for the system of this embodiment is the communication buffer region size equals 10 times 16 KB (reception joint handshake transmission buffer region)+2 KB (transmission buffer region)=162 KB, for example. Thus, with this embodiment, for the attainment of similar performance, memory is reduced by 18 kB.

The system of a third embodiment of the present invention will now be described.

The system of the third embodiment is similar to that of the second embodiment, except that the third embodiment has a client device configuration differing from that of the second embodiment. The system of the third embodiment will therefore be discussed with reference to differences from the second embodiment, and explanation with regard to items of similarity will be omitted.

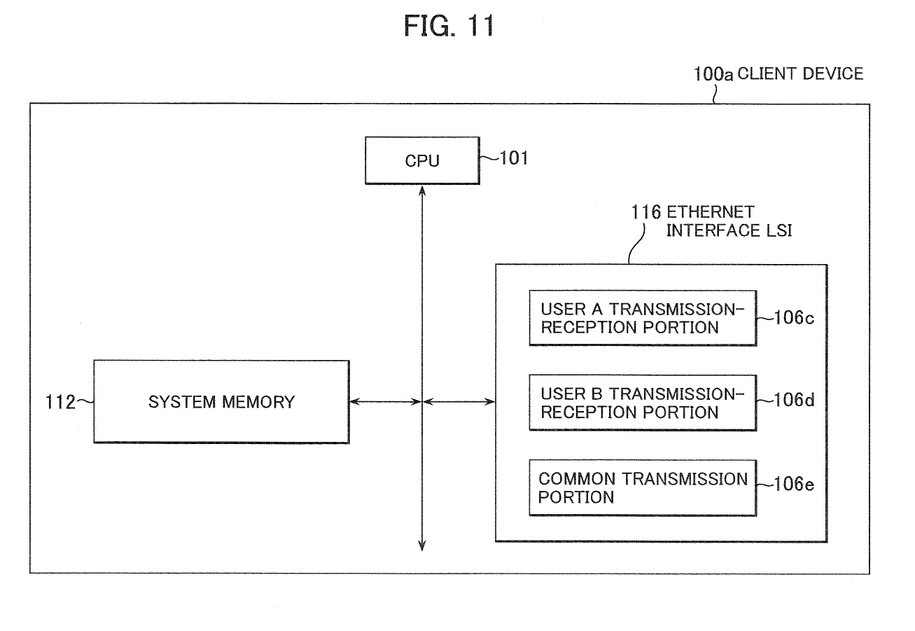

FIG. 11 is a block diagram showing various functions of the client device in accordance with the third embodiment of the present invention.

The client device 100a includes a CPU 101, a system memory 112, and an Ethernet interface LSI 116.

The Ethernet interface LSI 116 includes a user A transmission-reception portion 106c, having functions similar to those of the user A transmission-reception buffer region 102a, a user B transmission-reception portion 106d, having functions similar to those of the user B transmission-reception buffer region 102b, and a common transmission portion 106e, having functions similar to those of the common transmission buffer region 102c.

The system memory 112 performs various functions other than those functions transferred from the system memory 102 to the Ethernet interface LSI 116.

Operation of the system of the third embodiment will now be explained in further detail.

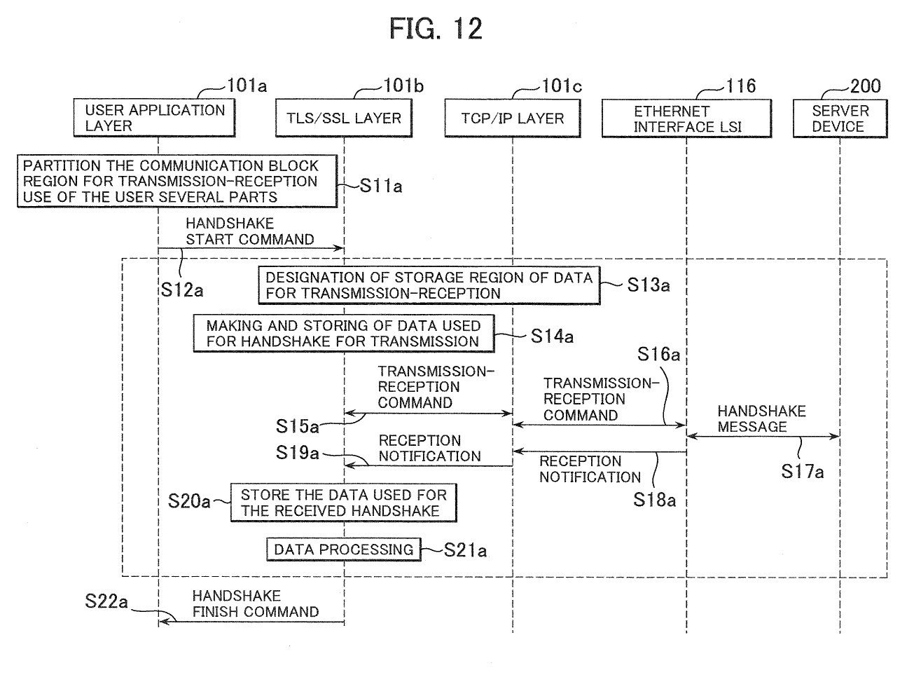

FIG. 12 is a sequence diagram showing operations of the handshake phase of the third embodiment.

First, the user application layer 101a allocates a common transmission buffer region (2 KB) and a communication block region for transmission-reception use, which is provided for each of multi-users (16 KB each) of the Ethernet interface LSI 116, and these regions are allocated for each of the multi-users (step S11a).

Thereafter, the user application layer 101a transmits a handshake start command to the TLS/SSL layer 101b (step S12a).

In step S13a, the TLS/SSL layer 101b sets the communication block region (storage region) used for transmission-reception and allocated to each user at step S11a. Specifically, the communication block region for data transmission-reception of user A is set to the user A transmission-reception portion 106c (FIG. 11), and the communication block region for data transmission-reception of user B is set to the user B transmission-reception portion 106d (FIG. 11).

Thereafter, the TLS/SSL layer 101b creates handshake data to be transmitted to the server device 200, and these data are stored in the user A transmission-reception portion 106c (FIG. 11) and the user B transmission-reception portion 106d (FIG. 11) (step S14a).

Steps S15a through S19a are similar to steps S16 through S20. Here, by establishment of the user A transmission-reception portion 106c (FIG. 11) and the user B transmission-reception portion 106d (FIG. 11) in place of the transmission portion 106a (FIG. 6), the handshake phase can be performed in parallel for each user without necessitating exclusive control.

When the TLS/SSL layer 101b receives reception notification from the TCP/IP layer 101c, the TLS/SSL layer 101b stores the received data used for the handshake in the user A transmission-reception portion 106c (FIG. 11) and in the user B transmission-reception portion 106d (FIG. 11) (step S20a).

Steps 21a and S22a are similar to steps S23 and S24.

In the handshake phase, the operations of steps S13a through S21a are repeated for each user (enclosed by dashed line within FIG. 11).

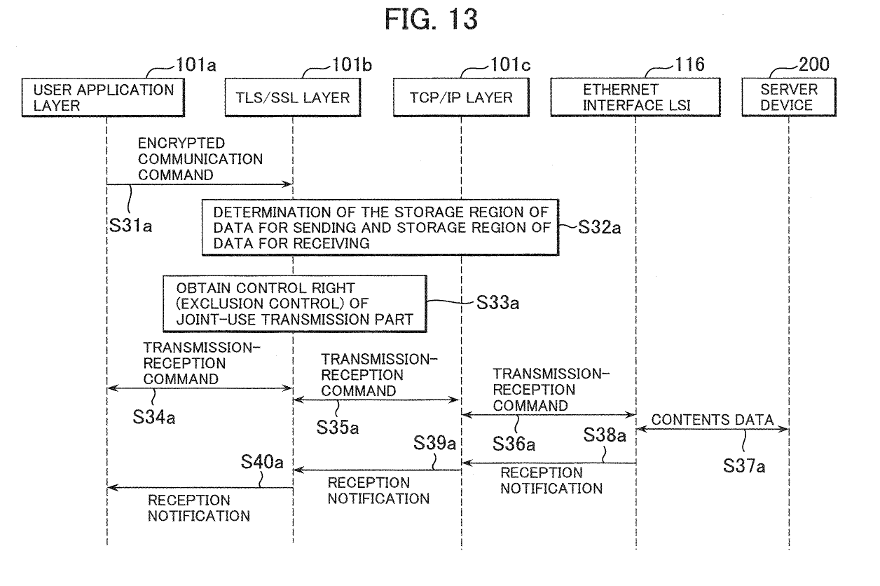

FIG. 13 is a sequence diagram showing operations of the data transfer phase of the third embodiment.

Step S31a is similar to step S31.

Thereafter, in step S32a, the TLS/SSL layer 101b assigns a storage region of data to be transmitted to the common transmission portion 106e (FIG. 11), assigns a storage region for receiving encrypted data of user A to the user A transmission-reception portion 106c (FIG. 11), and assigns a storage region for receiving encrypted data of user B to the user B transmission-reception portion 106d (FIG. 11).

The TLS/SSL layer 101b obtains the control right (exclusive control) of the common transmission portion 106e (FIG. 11) (step S33a).

Steps S34a through S40a are similar to steps S34 through S40.

A result similar to that of the system of the second embodiment is thereby obtained by the third embodiment.

According to the system of the third embodiment, since transmission-reception of data used for the handshake can be executed without necessitating exclusive control in the handshake phase, efficiency of processing is improved.

Embodiments of a communication program, communication method, and communication device utilizing encryption and authentication security technology have now been explained. However, the embodiments of the present invention are not limited to this detailed description contained herein, and the configurations of each part can be replaced by any configuration having encryption security technology and authentication having similar functions in accordance with embodiments of the present invention. Also, other arbitrary configuration parts and steps in accordance with embodiments of the present invention may be appended to the working examples.

Embodiments may also combine any two or more configurations (characteristics) from among all of the aforementioned embodiments.

Although the above embodiments have been explained as applications of TLS/SSL communication, the embodiments are not limited to TLS/SSL communication, and can be applied to various communication protocols that generally adhere to the following conditions (1) through (4).

(1) Prior to the “phase for transfer of content data” (i.e., the data transfer phase in the case of TLS/SSL communication), the protocol has a “phase for performance of negotiation relating to the transfer of content data and for authentication of the opposing user” (i.e., the handshake phase in the case of TLS/SSL communication).

(2) In the “phase for performance of negotiation relating to the transfer of content data and for authentication of the opposing user”, transmission-reception of data between the communication device and the server device is performed alternately.

(3) In the “phase of transfer of content data”, non-alternating performance is permissible for the transfer of data between the communication device and the server device, and a reception-use buffer region may be retained for each user.

(4) The minimum size required for the reception buffer region for reception of data is greater than or equal to the minimum size required for the transmission buffer region used for transmission.

Also, the server device of various embodiments of the present invention may have those functions provided to the client devices 100 and 100a shown in the exemplary embodiments.

Various features of the illustrative working examples above can particularly be applied with advantage to portable terminal apparatuses.

The aforementioned processing functions can also be implemented by a computer or other processing device (herein interchangeably referred to as a “computer”). A program that includes the processing functions that the client devices 100 and 100a have is implemented by executing the program on the computer. The program may be recorded to a recording medium, for example, which can be read by the computer. Examples of a recording medium that can be read by the computer include a magnetic recording device, optical disk, optical-magnetic recording medium, semiconductor memory, or the like. Examples of a magnetic recording device include a hard disk device (HDD), flexible disk (FD), magnetic tape, and the like. Examples of the optical disk are a DVD (Digital Versatile Disc), DVD-RAM (Random Access Memory), CD-ROM (Compact Disc Read Only Memory), CD-R (Recordable)/RW (Re-Writable), or the like. Examples of optical-magnetic recording medium include a MO (Magneto-Optical disk) and the like.

When the program is distributed, for example, a transportable recording medium (DVD, CD-ROM, or the like) containing the recorded program may be used. The program may also be stored beforehand on the memory device of a server computer, and this program may be transferred to another computer from the server computer through a network, for example.

The computer executing the communication program, for example, may store a program recorded on a transportable recording medium or a program transferred from the server computer in the memory of the executing computer. Thereafter, the computer reads the program from the computer's own memory device and executes processing according to the program. Also, the computer may be capable of directly reading the program from the transportable recording medium and then executing processing according to this program. Also, the computer may be capable of causing sequential transfer of each program from the server computer and execution of processing according to the received programs.

Example embodiments of the present invention have now been described in accordance with the above advantages. It will be appreciated that these examples are merely illustrative of the invention. Many variations and modifications will be apparent to those skilled in the art.

What is claimed is:

1. An encryption communication method for performing communication that includes a data transfer phase for transmission of content data and a handshake phase for user authentication or agreement on the transmission method for content data, the method comprising:
storing one set of a plurality of content data for multiple users in a common transmission communication region provided for the multiple users;
transferring the stored one set of the plurality of content data during the data transfer phase when transferring content data of the multiple users to a communication target device; and
receiving the stored one set of the plurality of content data using a plurality of transmission-reception communication regions provided for each of the multi users.

2. The encryption communication method according to claim 1, wherein data transmission in the handshake phase is performed using at least one of the plurality of transmission-reception communication regions.

3. The encryption communication method according to claim 1, further comprising:
generating a message for each user to be transmitted to the communication target device during the handshake phase; and
storing the generated message for each user in one of the transmission-reception communication regions.

4. The encryption communication method according to claim 1, further comprising:
transferring content data using at least one of the plurality of the transmission-reception communication regions to the communication target device during the handshake phase.

5. The encryption communication method according to claim 3, further comprising:
transmitting each of the messages stored in the transmission-reception communication regions.

6. The encryption communication method according to claim 1, wherein the size of the transmission-reception communication region is larger than the size of the common transmission communication region.

7. The encryption communication method according to claim 1, wherein the communication is TLS/SSL communication.

8. An encryption communication system for performing communication, the communication including a data transfer phase for transmission of content data and a handshake phase for user authentication or agreement on the transmission method for content data, the system comprising:
a common transmission communication region, provided for multiple users, configured to store one set of a plurality of content data for multiple users when transferring content data for the multiple users to a communication target device; and
a plurality of transmission-reception communication regions, at least one of the plurality of transmission-reception communication regions provided for each of the multiple users and configured to receive data.

9. The encryption communication system according to claim 8, wherein the common transmission communication region is used for data transmission during the handshake phase.

10. The encryption communication system according to claim 8, further comprising:
a message generation circuit configured to generate a message for each user to be transmitted to the communication target device during the handshake phase and to store each generated message in at least one of the plurality of transmission-reception communication regions.

11. The encryption communication system according to claim 8, further comprising:
a exclusive control circuit configured to control transfer only of content data stored in at least one of the plurality of the transmission-reception communication regions to the communication target device during the handshake phase.

12. The encryption communication system according to claim 8, further comprising:
a transmission circuit configured to transmit each message stored in the at least one of the plurality of transmission-reception communication regions.

13. The encryption communication system according to claim 8, wherein the size of each of the plurality of transmission-reception communication regions is larger than the size of the transmission communication region.

14. The encryption communication system according to claim 8, wherein the communication is TLS/SSL communication.

15. The encryption communication system according to claim 8, wherein at least one of the plurality of transmission-reception communication regions is provided in a system memory.

16. The encryption communication system according to claim 8, wherein at least one of the plurality of transmission-reception communication regions is provided in an interface for connecting with a network.

17. A encryption communication program for performing communication, the program including a data transfer phase for transmission of content data and a handshake phase for user authentication or agreement on the transmission method for content data, the program comprising:
a common transmission communication region, the region being provided for the multiple users and configured to store one of a plurality of content data for multiple users when transferring the content data for the multiple users to a communication target device; and
a plurality of transmission-reception communication regions, at least one of the plurality of transmission-reception communication regions being provided for each of the multiple users, each of the plurality being configured to receive data;
wherein transmitting and receiving data is performed by a processing device.

18. The encryption communication program according to claim 17, wherein the common transmission communication region is used for data transmission during the handshake phase.

19. The encryption communication program according to claim 17, further comprising:
a message generation portion configured to generate a message for each of the multiple users to be transmitted to the communication target device during the handshake phase and to store each of the generated messages in at least one of the transmission-reception communication regions.

20. The encryption communication program according to claim 17, further comprising:
a exclusive control portion configured to control transfer only of content data stored in the transmission-reception communication region to the communication target device during the handshake phase.
